(19) United States
(12) Patent Application Publication
(10) Pub. No.: US 2007/0217591 A1
(43) Pub. Date: Sep. 20, 2007

(54) Status notification system for a voice communications telephone, voice communications telephone, status management apparatus, and notification method therefor

(75) Inventor: Kenichi Yasuma, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/714,748

(22) Filed: Mar. 7, 2007

(30) Foreign Application Priority Data
Mar. 17, 2006 (JP) 2006-073897

(51) Int. Cl. H04M 3/42

(52) U.S. Cl. 379/202.01

(57) ABSTRACT

A status notification system for notifying a status of a voice communications telephone, the system includes a plurality of voice communications telephones registered to the same group, a status management apparatus managing a status of the plurality of voice communications telephones, and a network connecting the plurality of voice communications telephones to the status management apparatus. The plurality of voice communications telephones includes a status notification button notifying a self-status of one of the plurality of voice communications telephones to the status management apparatus, and the self-status is notified to the status management apparatus through the network by operating the status notification button.

### BACKGROUND OF THE INVENTION

1. Field of the Invention

The present invention relates to a status notification system for a voice communications telephone, a voice communications telephone, a status management apparatus, and a notification method therefor.

2. Description of the Related Art

As regards a conventional telephone, an originator side is given priority over an recipient side, and therefore a user on the recipient side may not find the telephone to be user-friendly. Recently, various services have been actively developed for the recipient side which allows the user to set a do-not-disturb function, a function of sounding different ringer for each originator, or a function of notifying an originator's number. However, service functions on the originator side may not be sufficient either. For example, even when a user on the recipient side is in a state (presence) where the user cannot answer the phone, a user on the originator side cannot be informed of in advance the state of the user at the other end. Therefore, the user on the originator side vainly makes a call for many times or leaves a message on the answering machine. Accordingly, it is preferable that the user on the originator side be able to be informed of the status of the user on the recipient side in advance.

Meanwhile, an application for real time data communication such as instant messaging has been coming along in recent years in the field of data communication using a personal computer (PC), a personal digital assistant (PDA), or the like. In order to implement the instant messaging service with ease, Japanese Patent Laid-Open No. 2004-348483 (hereinafter, referred to as Related Document 1) proposes a system as follows. Related Document 1 discloses a system in which a status (presence) of an individual member is notified to a server so that each member can be informed of the statuses (presence) of the other members in advance. In this case, the status (presence) of an individual member refers to, for example, whether a terminal of a registered member is connected to a network, whether each terminal is available for communication, or what kind of emotional state each member has. A graphic user interface (GUI) or the like is used for informing the statuses.

The technique disclosed in Related Document 1 is implemented by using a data communication function provided for a PC, a PDA, a mobile phone, or the like. By using the data communication function, the status (presence) of each member registered in a group is informed to a status management apparatus such as a server, thereby allowing each user to know the status of other users in advance. However, in a case where a fixed-line phone or the like is used as the voice communications telephone, there occurs a problem that the current status of the user of the voice communications telephone cannot be informed in advance to a party at the other end.

### SUMMARY OF THE INVENTION

In view of the foregoing and other exemplary problems, drawbacks, and disadvantages of the related art methods and structures, exemplary feature of the present invention is to provide a status notification system for a voice communications telephone, a voice communications telephone, a status management apparatus, and a notification method therefor, which are used for notifying a current status of a user of the voice communication telephone.

A status notification system for notifying a status of a voice communications telephone according to the present invention, the system includes a plurality of voice communications telephones registered to the same group, a status management apparatus managing a status of the plurality of voice communications telephones, and a network connecting the plurality of voice communications telephones to the status management apparatus. The plurality of voice communications telephones includes a status notification button notifying a self-status of one of the plurality of voice communications telephones to the status management apparatus, and the self-status is notified to the status management apparatus through the network by operating the status notification button.

A voice communications telephone according to the present invention includes a status notification button for notifying outward a self-status of the voice communications telephone. The voice communications telephone notifies outward the self-status through a network by operating the status notification button.

A status management apparatus for managing a status of a voice communications telephone includes a status management table registering status of a plurality of voice communications telephones. The status management apparatus, upon receiving the self-status from any one of the plurality of voice communications telephones, updates contents registered in the status management table and distributes the contents of the status management table thus updated to the plurality of voice communications telephones. A notification method of notifying a status of a voice communications telephone according to the present invention, the method being used in a status notification system including a plurality of voice communications telephones registered in the same group in advance, a status management apparatus for managing a status of the plurality of voice communications telephones, and a network for connecting the plurality of voice communications telephones and the status management apparatus, the method includes providing the plurality of voice communications telephones with a status notification button for notifying a self-status of one of the plurality of voice communications telephones to the status management apparatus, operating the status notification button according to a change in the self-status, generating a status notification signal for notifying the change in the self-status, and notifying the status notification signal to the status management apparatus through the network.

Therefore, the status notification system for a voice communications telephone, the voice communications telephone, the status management apparatus, and the notification method therefor according to the present invention adopt the above-mentioned structure and method, and therefore have the effect of notifying a current status of a user of the voice communications telephone.

### BRIEF DESCRIPTION OF THE DRAWINGS

The exemplary aspects, features and advantages of the present invention will become more apparent from the following detailed description when taken in conjunction with the accompanying drawings wherein:

FIG. 1 is a block diagram showing an example of a structure of a telephone-status notification system according to an embodiment of the present invention;

FIG. 2 is a schematic diagram showing an example of an operation panel of a telephone according to the embodiment of the present invention;

FIG. 3 is a schematic diagram showing an example of a display displayed on a status display device according to the embodiment of the present invention; and

FIG. 4 is a sequence chart showing a flow of a status notification signal.

### DETAILED DESCRIPTION OF THE PREFERRED EMBODIMENT

Exemplary aspects for carrying out the present invention will be described in detail below with reference to the drawings. The exemplary aspects described below show only illustrative examples in understanding the present invention, and the claims of the invention are not limited to these exemplary aspects.

Hereinafter, a detailed description is given of preferred embodiments of a status notification system for a voice communications telephone, a voice communications telephone, a status management apparatus, and a notification method therefor according to the present invention.

According to the present invention, a voice communications telephone such as a fixed-line phone is provided with a status notification button which is used for notifying a current status (presence) of a user of the telephone to a status management server, thereby making it possible for a party who is trying to call the telephone to be informed in advance of the status of the user of the telephone.

Next, a structure of an embodiment of the present invention is described in detail.

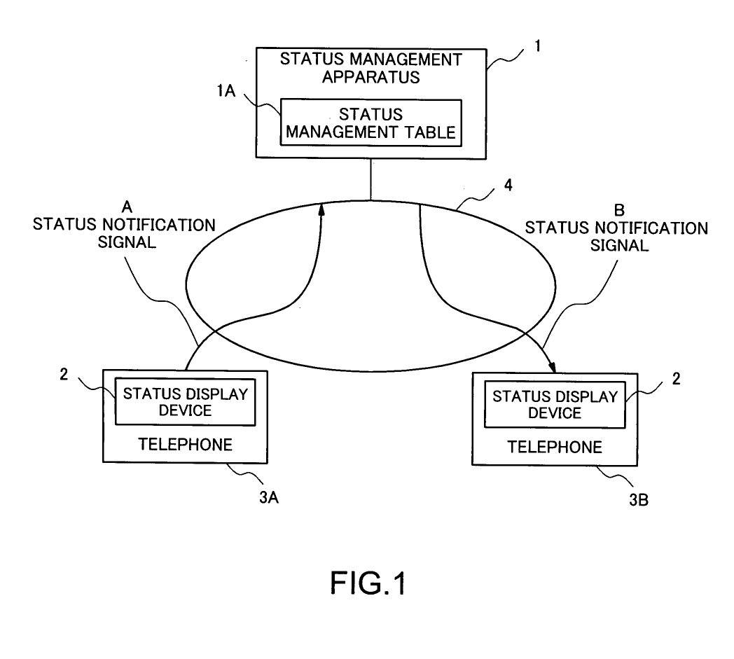

FIG. 1 is a block diagram showing an example of a structure of a telephone-status notification system according to the embodiment of the present invention. As shown in FIG. 1, the telephone-status notification system according to the embodiment of the present invention includes a status management apparatus 1, a plurality of telephones 3A and 3B, which belong to a group registered in advance, and a network 4. The status management apparatus 1 and the telephones 3A and 3B are connected to one another via the network 4. The telephones 3A and 3B each are provided with a status display device 2. The network 4 may be a public switched telephone network (PSTN) or a private branch exchange (PBX) for voice communication, or may be the Internet, an internet protocol (IP) telephone network, a local area network (LAN), or the like capable of transmitting voice information. FIG. 1 shows only two telephones as a minimum unit for the sake of simplifying the description, namely, the telephones 3A and 3B, connected to the network 4. However, the telephone-status notification system according to the present invention can also be applied to a case in which three or more telephones are connected to the network.

Among the telephones connected to the network 4, the telephones 3A and 3B are registered in advance as one group. The status management apparatus 1 registers current statuses of the users of the telephones 3A and 3B in a status management table 1A and manages the current statuses of the users of the telephones 3A and 3B. In this case, the current status shows whether the user is present, in a meeting, absent, taking time off, on another line, or the like. When a status (presence) of one of the users of the telephones in the group, for example, a user of the telephone 3A, changes, the status management apparatus 1 receives a status notification signal A from the telephone 3A. Thus, the status management apparatus 1 updates the statuses of the users of the telephones 3A and 3B, so the current statuses of the users of the telephones 3A and 3B are managed as the latest statuses. The status notification signal A is used for notifying a current status (presence) of the user to the status management apparatus 1.

In a case where a status of one of the users of the plurality of telephones 3A and 3B managed as one group has changed and the status management apparatus 1 receives a status notification signal from the telephone of the user whose status has changed, the status management apparatus 1 notifies each of the telephones 3A and 3B in the group that the status of the telephone of the user has changed. Specifically, the status management apparatus 1, upon receiving a status notification signal A from, for example, the telephone 3A, notifies the telephones 3A and 3B that the status of the user of the telephone 3A has changed. The status management apparatus 1 sends a status notification signal B to each of the telephones 3A and 3B via the network 4, to thereby notify the change in status. The status notification signal B is used for notifying each of the telephones in the group of the current status (presence) of a user whose status has changed. The status notification signal B has a function of indicating that a status of one of the users of the telephones in the group has changed.

Further, the status management apparatus 1 receives, from one of the plurality of telephones 3A and 3B belonging to a group, a notification request signal for requesting a notification regarding the current statuses (presence) of the telephones 3A and 3B registered in the status management table 1A. In this case, the status management apparatus 1 sends back the current statuses (presence) of the telephones 3A and 3B in the group, as the status notification signal B, to the telephone which has requested the notification. The request of notification may be sent by any of the telephones belonging to the group or may be sent by a specific telephone designated in the group. In either case, the status notification signal B has a function of distributing the contents currently registered in the status management table 1A to the telephone as a requester which has sent the notification request signal.

Each of the telephones 3A and 3B is provided with the status display device 2. The status display device 2 displays the current statuses (presence) of the users of the telephones 3A and 3B belonging to the group registered in the status management table 1A. The status display device 2 may display the current statuses of all the users of the telephones belonging to the group, or may display the current status of a user of a specific telephone designated in the group. The current statuses of the users of the telephones 3A and 3B are transferred from the status management apparatus 1 via the network 4 and thereby displayed by the status display device 2. In this manner, the user of the telephone 3B can be informed of the status of the user of another telephone in the group, namely, the telephone 3A, by referring to the status display device 2B, before making a call to the telephone 3A.

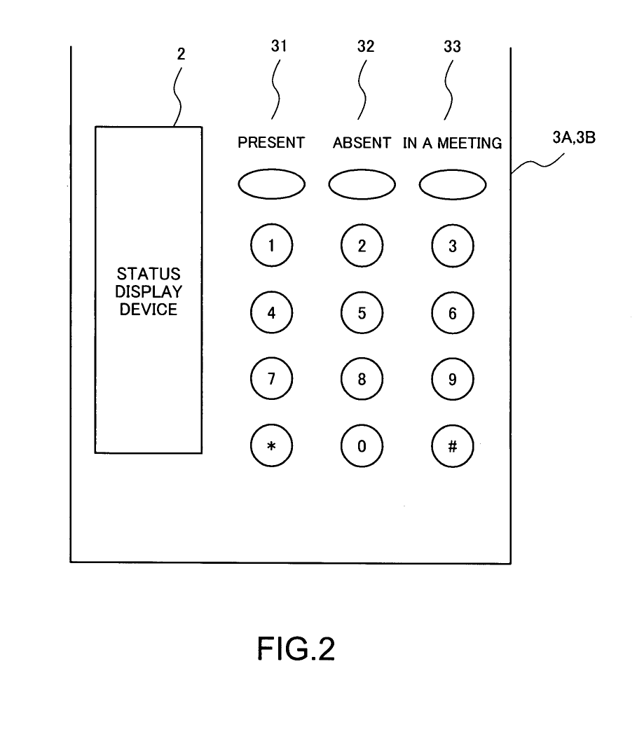

Each of the telephones 3A and 3B is provided with a status notification button which is used for notifying the status management apparatus 1 of the current status (for example, the user is present, in a meeting, absent, taking time off, or on another line) of the user of the telephone. FIG. 2 is a schematic diagram showing an example of an operation panel of a telephone according to the embodiment of the present invention. In the example shown in FIG. 2, the status notification buttons are arranged at the top of a numeric keypad on the operation panel of each of the telephones 3A and 3B. However, the arrangement of the status notification buttons is not limited to this. The status notification buttons may be provided to any part on the operation panel.

FIG. 2 shows an example in which three of the status notification buttons are provided. A “present” button 31 indicates that the user is present in the vicinity of the telephone (3A or 3B) and available to talk on the telephone (3A or 3B). A “absent” button 32 indicates that the user is absent and not available to talk on the telephone (3A or 3B). An “in-a-meeting” button 33 indicates that the user is in a meeting and not available to talk on the telephone (3A or 3B). The user may press one of those buttons to turn on the light, to thereby surely notify the current status of the user.

However, the status notification button is not limited to the above-mentioned example. The status notification button may be any button as long as the button indicates a status (presence) that needs to be notified to a party at the other end. For example, a button indicating that the user is on another line or a button indicating that the user is out on a business trip may also be used. However, it is preferable that at least a button capable of identifying whether the user is available or not to talk on the telephone be provided.

The user operates one of the status notification buttons according to the status of the user. As a result, the status (presence) of the user is notified as the status notification signal A to the status management apparatus 1. The status notification signal A may be sent for several times at predetermined interval, or may be repeatedly sent until the telephone receives a signal indicating the reception of the status notification signal A from the status management apparatus 1.

FIG. 2 shows a case where a plurality of different buttons is provided as the status notification buttons, so as to indicate each different status of the user. However, only one button may constitute the status notification button, and the status indicated by the button may be caused to change from one state to another state every time the button is pressed. Alternatively, a slide switch or a rotary button formed of a multi-contact switch may constitute the status notification button, and the switch may be set to a position corresponding to the status of the user so as to indicate the status of the user. Further, the status display device 2 attached to each of the telephones 3A and 3B may be formed of a touch panel, so the status display device 2 may also be used as the status notification button. In this case, a user may touch a part corresponding to the status of the user displayed on the status display device 2, and thereby the status of the user displayed may be changed accordingly. Alternatively, the user may touch to select the corresponding status from among the statuses displayed on the status display device 2, to thereby change the status of the user displayed.

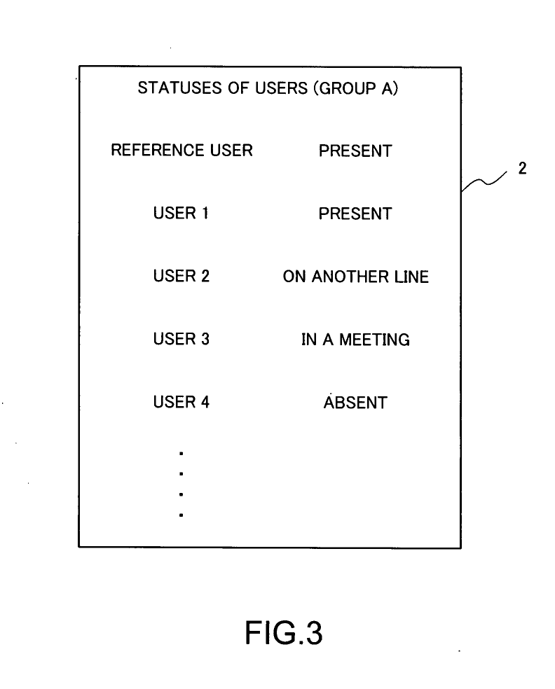

Next, FIG. 3 is a schematic diagram showing an example of an indication displayed on the status display device according to the embodiment of the present invention. The status display device 2 provided to each of the telephones 3A and 3B displays thereon the current statuses (presence) of the users of the telephones in a group to which the telephones 3A and 3B belong. FIG. 3 illustrates a case where the user of the telephone and a user 1 of another one of the telephones are present and available to talk on the phone. Further, it is illustrated in this case that a user 2 is on another line, a user 3 is in a meeting, and a user 4 is absent, that is, the users 2 to 4 are not available to answer the phone. In the display example of FIG. 3, the current statuses are indicated by character strings, but the current statuses may also be graphically displayed for better visibility. Alternatively, the current statuses may be displayed in colors for ready legibility. For example, the status where the user is present may be displayed in blue, the status where the user is on another line may be displayed in red, and the status where the user is absent for a meeting or the like may be displayed with no colors.

In the above-mentioned embodiment, the status display device 2 is internally provided to each of the telephones 3A and 3B. However, the status display device may also be externally provided to each of the telephones 3A and 3B. Alternatively, the status display device may also take the form of a display board mounted on a wall or the like, which may be provided independently of the telephones 3A and 3B.

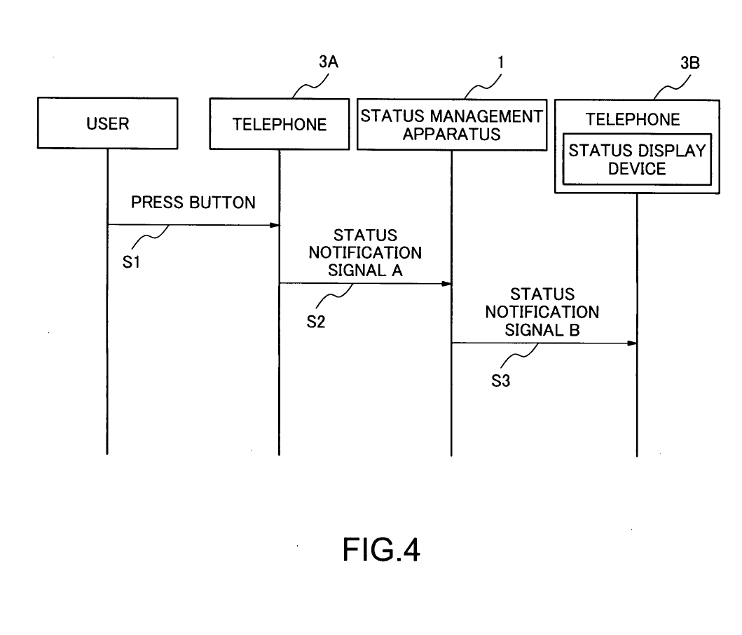

Next, an operation of the telephone-status notification system according to the embodiment of the present invention is described as follows. Description is made, with reference to FIG. 4, on a case where the status of the user of the telephone 3A in the system shown in FIG. 1 has been changed. FIG. 4 is a sequence chart showing a flow of a status notification signal. FIG. 4 shows a flow of a signal sequence when displaying the change in status on the status display device 2 of the telephone 3A.

In FIG. 4, the user of the telephone 3A presses any one of the status notification buttons 31 to 33 provided to the telephone 3A (sequence S1). The telephone 3A notifies, through the network 4, the status management apparatus 1 of the status notification signal A as information indicating the current status of the user (sequence S2). The status management apparatus 1 updates the status management table 1A based on the status notification signal A thus received. At the same time, the status management apparatus 1 notifies the information of the status management table 1A thus updated, as the status notification signal B, to the status display device 2 provided to each of the telephones 3A and 3B in the group (sequence S3). In this manner, the user of the telephone 3B can instantly be informed of the current status (presence) of the user of the telephone 3A with precision.

A transmission control protocol used for transmitting and receiving the status notification signals A and B through the network 4 may be based on a protocol conforming to a session initiation protocol (SIP) or the H.323 protocol which are designed to support Voice over Internet Protocol (VoIP) or an IP phone service. In some cases, an in-channel analog signal such as a multi-frequency (MF) signal may also be used as the status notification signal.

When the status notification signal B is notified to the telephones 3A and 3B by the status management apparatus 1, the telephones 3A and 3B each may output a notification tone so as to inform the user of the each of the telephones that the signal has been notified. Further, the telephones 3A and 3B each may give an audio notification to the user regarding the contents of the status notification signal B thus notified, instead of displaying the contents, or the telephones 3A and 3B each may display the contents of the status notification signal B along with the audio notification. The audio notification may be given by reading aloud the contents of the status notification signal B automatically every time when the status notification signal B is notified to the telephones 3A and 3B, or the audio notification may be given only when each user presses a dedicated button.

As described above, according to the embodiment of the present invention, a user of a telephone is capable of obtaining information regarding the status of a user of another telephone before making a call to another telephone, even when the user is using a voice communications telephone such as a fixed-line phone. A status notification button for notifying the status of the user is provided to the telephone, and each user operates the status notification button to notify the status of the user to a status display device via a status management apparatus, to thereby attain the above-mentioned object.

Also, the embodiment of the present invention produces an effect that each user can be informed of the status of each of the members in a group, such as whether the member is present or not or the use state of each of the telephones. The embodiment of the present invention further produces an effect that the status notification button for exclusive use provided to each of the telephones makes it easy for the user to notify the status of the user. When the notification is given by voice, there is produced another effect that even a visually handicapped person can be informed in advance of the status of the party at the other end.

It should be noted that the above-mentioned embodiment is merely a preferred embodiment of the present invention, and various modifications can be made without departing from the scope of the present invention.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

Further, the inventor's intent is to retain all equivalents of the claimed invention even if the claims are amended later during prosecution.

What is claimed is:

1. A status notification system for notifying a status of a voice communications telephone, the system comprising:
a plurality of voice communications telephones registered to the same group;
a status management apparatus managing a status of the plurality of voice communications telephones; and
a network connecting the plurality of voice communications telephones to the status management apparatus,
wherein the plurality of voice communications telephones comprises a status notification button notifying a self-status of one of the plurality of voice communications telephones to the status management apparatus, and
wherein the self-status is notified to the status management apparatus through the network by operating the status notification button.

2. A status notification system according to claim 1, wherein the status management apparatus, when receiving information regarding the self-status from any one of the plurality of voice communications telephones, distributes the information to the plurality of voice communications telephones.

3. A status notification system according to claim 1, wherein the status management apparatus comprises a status management table for managing the status of the plurality of voice communications telephones, updates contents registered in the status management table, upon receiving the self-status from any one of the plurality of voice communications telephones, and distributes the contents of the status management table thus updated to the plurality of voice communications telephones.

4. A status notification system according to claim 1, wherein the status notification button comprises a plurality of buttons indicating different status from each other.

5. A status notification system according to claim 1, wherein the status notification button notifies different status every time the button is pressed.

6. A status notification system according to claim 5, wherein the status notification button displays the different status which is to be notified, every time the button is pressed.

7. A status notification system according to claim 2, wherein the plurality of voice communications telephones comprises a status display unit for receiving the information distributed by the status management apparatus and displaying the information thus received.

8. A status notification system according to claim 3, wherein the plurality of voice communications telephones comprises a status display unit for receiving the contents of the status management table distributed by the status management apparatus and displaying the contents thus received.

9. A status notification system according to claim 3, wherein the plurality of voice communications telephones comprises a unit for receiving the contents of the status management table distributed by the status management apparatus and reading aloud the contents thus received.

10. A status notification system according to claim 1, further comprising a status display device, wherein:
the status management apparatus, upon receiving information regarding the self-status from any one of the plurality of voice communications telephones, transmits the information thus received to the status display device; and
the status display device displays the information thus transmitted.

11. A status notification system according to claim 1, wherein the plurality of voice communications telephones comprises at least one of a fixed-line phone and an Internet protocol phone.

12. A status notification system according to claim 1, wherein the network comprises at least one of a public telephone network, a private branch exchange, an Internet protocol telephone network, a local area network, and the Internet.

13. A voice communications telephone, comprising a status notification button for notifying outward a self-status of the voice communications telephone, wherein
the voice communications telephone notifies outward the self-status through a network by operating the status notification button.

14. A voice communications telephone according to claim 13, wherein the status notification button comprises a plurality of buttons indicating different status from each other.

15. A voice communications telephone according to claim 13, wherein the status notification button notifies different status every time the button is pressed.

16. A voice communications telephone according to claim 15, wherein the status notification button displays the different status which is to be notified, every time the button is pressed.

17. A voice communications telephone according to claim 13, further comprising a status display unit, wherein the status display unit receives information regarding a status of another voice communications telephone, the information being distributed through the network, and displays the information thus received.

18. A voice communications telephone according to claim 13, further comprising a status display unit, wherein
the status display unit receives contents of a status management table for managing a status of a plurality of voice communications telephones registered in advance in the same group, the contents being distributed through the network, and displays the contents thus received.

19. A voice communications telephone according to claim 13, further comprising a unit for receiving contents of a status management table, the contents being distributed through the network, and reading aloud the contents thus received.

20. A voice communications telephone according to claim 13, wherein the voice communications telephone comprises at least one of a fixed-line phone and an Internet protocol phone.

21. A status management apparatus for managing a status of a voice communications telephone, comprising a status management table registering a status of a plurality of voice communications telephones, wherein
the status management apparatus, upon receiving the self-status from any one of the plurality of voice communications telephones, updates contents registered in the status management table and distributes the contents of the status management table thus updated to the plurality of voice communications telephones.

22. A notification method of notifying a status of a voice communications telephone, the method being used in a status notification system comprising a plurality of voice communications telephones registered in the same group in advance, a status management apparatus for managing a status of the plurality of voice communications telephones, and a network for connecting the plurality of voice communications telephones and the status management apparatus, the method comprising:
providing the plurality of voice communications telephones with a status notification button for notifying a self-status of one of the plurality of voice communications telephones to the status management apparatus;
operating the status notification button according to a change in the self-status;
generating a status notification signal for notifying the change in the self-status to the status management apparatus; and
notifying the status notification signal to the status management apparatus through the network.

23. A method according to claim 22, further comprising distributing the status notification signal by the status management apparatus through the network to the plurality of voice communications telephones.

24. A method according to claim 22, further comprising displaying a change in the self-status based on the status notification signal.

25. A method according to claim 22, wherein the status notification button notifies different status every time the button is pressed.

26. A method according to claim 22, wherein the status notification button displays the different status which is to be notified, every time the button is pressed.

27. A method according to claim 22, wherein the status notification signal notifies a current status of a user.

28. A method according to claim 22, wherein the status notification signal notifies a status indicating whether a user is present or not.

29. A method according to claim 22, wherein the status notification signal notifies a status indicating whether a user is available or not to use a self-telephone.
